(19) United States
(12) Patent Application Publication
(10) Pub. No.: US 2020/0254720 A1
(43) Pub. Date: Aug. 13, 2020

(54) ELASTIC NON-WOVEN FABRIC MANUFACTURED BY BONDING A PRE-STRETCHED ELASTIC FILM AND ELASTIC CLOTHS

(71) Applicant: GOLDEN PHOENIX FIBERWEBS, INC., Tainan City (TW)

(72) Inventors: Kenneth CHENG, Taipei City (TW); Eric SHYUU, Taipei City (TW)

(73) Assignee: GOLDEN PHOENIX FIBERWEBS, INC., Tainan City (TW)

(21) Appl. No.: 16/786,425

(22) Filed: Feb. 10, 2020

(30) Foreign Application Priority Data
Feb. 11, 2019 (TW) 108201811

(51) Int. Cl. B32B 5/26; D04H 3/007; D04H 3/016; D04H 3/147

(52) U.S. Cl. CPC B32B 5/26; D04H 3/007; D04H 3/16; D04H 3/147; B32B 2307/51; D04H 3/016

(57) ABSTRACT

An elastic non-woven fabric, manufactured by bonding a pre-stretched elastic film and elastic cloths, includes an elastic film with a stretch range of 0-300% and two elastic cloths each with a stretchability of 150-300%. While at the second natural width, the two elastic cloths are respectively bonded to upper and lower surfaces of the elastic film pre-stretched to a first stretched width. By bonding the two elastic cloths to the elastic film after stretching the elastic film in advance, the elastic non-woven fabric of the present invention can have high stretchability and high tensile strength and thus will not have serious wrinkles on the surfaces thereof and will not be easily torn broken. Because the stretchability of the elastic non-woven fabric is greatly improved, the user can use a smaller cutting width to divide each cylindrical master-roll into more cylindrical sub-rolls, thereby improving the production efficiency.

### CROSS-REFERENCE TO RELATED APPLICATION

This application claims the priority of Taiwanese patent application No. 108201811, filed on Feb. 11, 2019, which is incorporated herewith by reference.

### BACKGROUND OF THE INVENTION

### 1. Field of the Invention

The present invention relates to an elastic non-woven fabric, and more particularly, to an elastic non-woven fabric manufactured by bonding a pre-stretched elastic film and elastic cloths.

### 2. The Prior Arts

Generally, when considering hygiene and using safety, sanitary products, such as masks, disposable clothing, baby diapers or adult diapers, are usually provided in one-time or disposable forms to avoid contamination by germs or harmful substances. Since these products will be in contact with a user's skin for a period of time, the air permeability requirements thereof are stricter to prevent discomfort or allergy, itching, and even rash of the skin caused by stuffiness or moisture.

Because the non-woven fabrics made of plastic materials have the advantages of being easy to manufacture and process, good chemical resistance, durability and low cost, they have been widely used in many sanitary products. However, the non-woven fabrics have poor stretchability, which may cause inconvenience in applications, such as diapers, which needs to be worn. Therefore, the non-woven fabrics called elastic non-woven fabrics, which can improve the stretchability, have been developed in this industry.

In related arts, for the process of manufacturing conventional elastic non-woven fabrics, generally, a piece of elastic film is stretched in advance, and then two pieces of ordinary inelastic non-woven fabrics, which are respectively used as upper and lower layers, are bond to the elastic film therebetween in a sandwich manner.

However, the ordinary inelastic non-woven fabrics have almost no stretchability, and thus are stretched to the limit after being slightly stretched. In addition, the weft-direction stretching limit of the elastic non-woven fabrics is equal to the weft-direction stretching limit of the ordinary inelastic non-woven fabrics. Therefore, there are several problems of the conventional elastic non-woven fabrics: first, the stretchability is poor; second, the tensile strength is insufficient and thus the conventional elastic non-woven fabrics are easily torn broken; third, the surface thereof is heavily wrinkled; and fourth, the cutting width is large, such that each cylindrical master-roll of the elastic non-woven fabrics cannot be divided into more cylindrical sub-rolls of the elastic non-woven fabrics, thereby the production efficiency is low.

### SUMMARY OF THE INVENTION

A main objective of the present invention is to provide an elastic non-woven fabric manufactured by bonding a pre-stretched elastic film and elastic cloths, wherein the elastic non-woven fabric has high stretchability and high tensile strength, such that the elastic non-woven fabric will not have serious wrinkles on the surfaces thereof and will not be easily torn broken.

Another objective of the present invention is to provide an elastic non-woven fabric manufactured by bonding a pre-stretched elastic film and elastic cloths, wherein a smaller cutting width can be used to divide each cylindrical master-roll of the elastic non-woven fabric into more cylindrical sub-rolls of the elastic non-woven fabric, thereby improving the production efficiency.

In order to achieve the foregoing objectives, the present invention provides an elastic non-woven fabric, which is manufactured by bonding a pre-stretched elastic film and elastic cloths, includes an elastic film and two elastic cloths. A width that the elastic film is under a condition of equal to 100% of a natural width thereof is defined as a first natural width; a width that the elastic film is under a condition of more than 100% of the natural width thereof is defined as a first stretched width; and a stretch range that the elastic film is stretched from the first natural width to the first stretched width is 0-300%. Each of the elastic cloths has a stretchability of 150-300%; a width that each of the elastic cloths is under a condition of equal to 100% of a natural width thereof is defined as a second natural width; the second natural width of each of the elastic cloths is equal to the first stretched width of the elastic film; and under a condition that the two elastic cloths are maintained at the second natural width thereof, the two elastic cloths are respectively bonded to an upper surface and a lower surface of the elastic film which has been stretched to the first stretched width.

Preferably, the stretch range of the elastic film is 200%, and the stretchability of each of the elastic cloths is 200%.

Preferably, under the condition that the two elastic cloths are maintained at the second natural width thereof, the two elastic cloths are respectively bonded, by means of ultrasonic, hot pressing or adhesive, to the upper surface and the lower surface of the elastic film which has been stretched to the first stretched width.

Preferably, the elastic film includes a polystyrene copolymer material such as a styrene-butadiene block copolymer, a styrene-ethylene-butylene-styrene block copolymer (SEBS) or a thermoplastic polyolefin elastomer (TPO), or includes a thermoplastic polystyrene elastomer (TPS).

Preferably, each of the elastic cloths includes polypropylene fibers or polyethylene fibers.

The effectiveness of the present invention is that by bonding the two elastic cloths respectively to the upper surface and the lower surface of the elastic film after stretching the elastic film in advance, it is possible for the elastic non-woven fabric of the present invention to have high stretchability and high tensile strength. Therefore, the elastic non-woven fabric will not have serious wrinkles on the surfaces thereof and will not be easily torn broken.

In addition, because the stretchability of the elastic non-woven fabric is greatly improved, the user can use a smaller cutting width. Therefore, in the factory, it is possible to divide each cylindrical master-roll of the elastic non-woven fabric into more cylindrical sub-rolls of the elastic non-woven fabric, thereby improving the production efficiency.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flow chart of the present invention;

FIG. 2 is a cross-sectional view of the present invention under the condition of equal to 100% of the natural width thereof;

FIG. 3 is a cross-sectional view of the present invention under the condition of equal to 200% of the natural width thereof; and

FIG. 4 is a cross-sectional view of the present invention under the condition of equal to 400% of the natural width thereof.

### DETAILED DESCRIPTION OF THE PREFERRED EMBODIMENT

Embodiments of the present invention will be described in more detail below with reference to the drawings and the reference numerals, such that those skilled in the art can implement it after studying this specification.

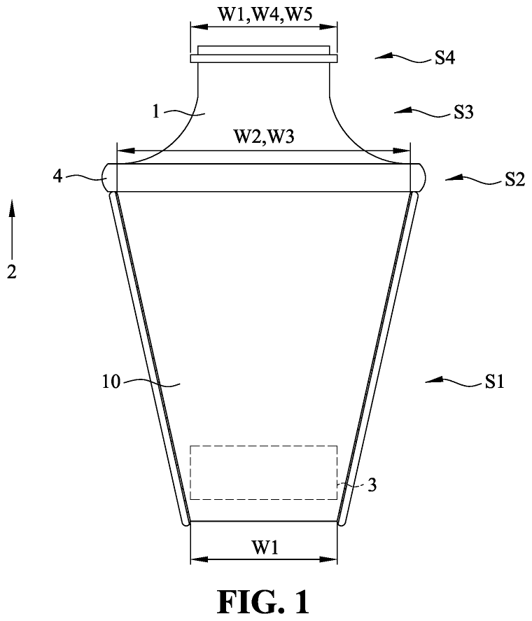

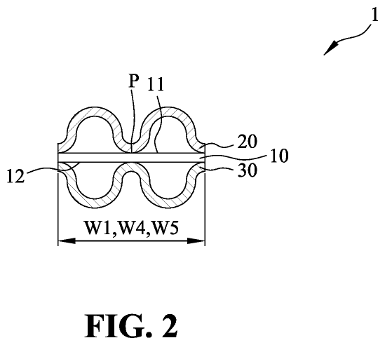

Referring to FIG. 1 and FIG. 2, which illustrate a flow chart of the present invention and a cross-sectional view of the present invention under a condition of equal to 100% of a natural width thereof, respectively. As shown in FIG. 1 and FIG. 2, the present invention provides an elastic non-woven fabric 1, which is manufactured by bonding a pre-stretched elastic film and elastic cloths, includes an elastic film 10 and two elastic cloths 20 and 30.

A width that the elastic film 10 is under a condition of equal to 100% of a natural width thereof is defined as a first natural width W1, and a width that the elastic film 10 is under a condition of more than 100% of the natural width thereof is defined as a first stretched width W2. “The condition of equal to 100% of the natural width of the elastic film 10” refers to a state that the elastic film 10 has not been stretched; and “the condition of more than 100% of the natural width of the elastic film 10” refers to a state after the elastic film 10 is stretched. A stretch range that the elastic film 10 is stretched from the first natural width W1 to the first stretched width W2 is 0-300%.

Each of the elastic cloths 20 and 30 has a stretchability of 150-300%. A width that each of the elastic cloths 20 and 30 is under a condition of equal to 100% of a natural width thereof is defined as a second natural width W3; and a width that each of the elastic cloths 20 and 30 is under a condition of more than 100% of the natural width thereof is defined as a second stretched width. The second natural width W3 of each of the elastic cloths 20 and 30 is equal to the first stretched width W2 of the elastic film 10. Under the condition that the two elastic cloths 20 and 30 are maintained at the second natural width W3, the two elastic cloths 20 and 30 are respectively bonded to an upper surface 11 and a lower surface 12 of the elastic film 10 which has been stretched to the first stretched width W2.

In a preferable embodiment, under the condition that the two elastic cloths 20 and 30 are maintained at the second natural width W3, the two elastic cloths 20 and 30 are respectively bonded, by means of ultrasonic, hot pressing or adhesive, to the upper surface 11 and the lower surface 12 of the elastic film 10 which has been stretched to the first stretched width W2.

Further, the elastic film 10 includes a polystyrene copolymer material such as a styrene-butadiene block copolymer, a styrene-ethylene-butylene-styrene block copolymer (SEBS) or a thermoplastic polyolefin elastomer (TPO), or includes a thermoplastic polystyrene elastomer (TPS).

It is well known that the thermoplastic polystyrene elastomers (TPS) mentioned above, which are also referred to as styreneic block copolymers (SBCs), are a type of thermoplastic elastomer with the largest production currently in the world and having the properties most similar to that of rubber. Currently, there are mainly four types in the species of the thermoplastic polystyrene elastomer series, that is: styrene-butadiene-styrene block copolymer (SBS), styrene-isoprene-styrene block copolymer (SIS), styrene-ethylene-butylene-styrene block copolymer (SEBS) and styrene-ethylene-propylene-styrene block copolymer (SEPS), wherein SEBS and SEPS are hydrogenated copolymers of SBS and SIS, respectively.

Further, the hard segment of the thermoplastic polyolefin elastomer (TPO) is a polyolefin material such as polypropylene (PP) or polyethylene (PE) or the like, wherein the soft segment thereof is a rubber such as ethylene propylene diene monomer (EPDM) and the like. Generally, TPO is formed by polymerization using metallocene as a catalyst, wherein the hard segment portion and the soft segment portion are directly combined by a covalent bond, and thus TPO is also referred to as M-POE.

In addition, each of the elastic cloths 20 and 30 includes polypropylene fibers or polyethylene fibers.

Specifically, in step S1, the elastic film 10 is firstly fed into a stretching machine (not illustrated) and both sides of the elastic film 10 are clamped by a plurality of clamps of the stretching machine. The elastic film 10 is moved in a first direction 2 and the clamps gradually stretch the elastic film 10 laterally outward, so that the width of the elastic film 10 is gradually stretched from the first natural width W1 to the first stretched width W2. the elastic film 10 passes through a ceramic heating plate 3 during the movement of the elastic film 10 in the first direction 2, such that the ceramic heating plate 3 heats the elastic film 10, in order to control the temperature of the elastic film 10 and improve the stretch stability of the elastic film 10.

In step S2, the elastic film 10 is moved to a bonding station 4 in the first direction 2. Two elastic cloths 20 and 30 with the second natural width W3, which is equal to the first stretched width W2 of the elastic film 10, are selected to use. Under the condition that the two elastic cloths 20 and 30 are maintained at the second natural width W3, the two elastic cloths 20 and 30 are respectively bonded to the upper surface 11 and the lower surface 12 of the elastic film 10 which has been stretched to the first stretched width W2, to obtain the elastic non-woven fabric 1.

In step S3, the elastic non-woven fabric 1 continues to be moved in the first direction 2 and then leaves the bonding station 4. At this time, the elastic film 10 is contracted naturally and gradually from the first stretched width W2 back to the first natural width W1 due to the restoring force thereof. Meanwhile, the two elastic cloths 20 and 30 are affected by the contraction of the elastic film 10 and thus contracted inward from the second natural width W3 to a contracted width W4 (that is, a width under a condition of less than 100% of the natural width thereof). Then, since there are a plurality of bonding points P between the two elastic cloths 20 and 30 and the elastic film 10, the two elastic cloths 20 and 30 are contracted inward into wave shapes. Therefore, as shown in FIG. 2, when the elastic non-woven fabric 1 has a third natural width W5 that under a condition of equal to 100% of a natural width thereof (that is, a width of a natural state thereof before being stretched), the elastic film 10 appears a flat shape while the two elastic cloths 20 and 30 appear wave shapes. In other words, the third natural width W5, which is the width that the elastic non-woven fabric 1 is under a condition of equal to 100% of a natural width thereof, is equal to the first natural width W1, which is the width that the elastic film 10 is under a condition of equal to 100% of the natural width thereof, and is also equal to the contracted width W4 of the two elastic cloths 20 and 30.

In step S4, the elastic non-woven fabric 1 is rolled into a cylindrical shape.

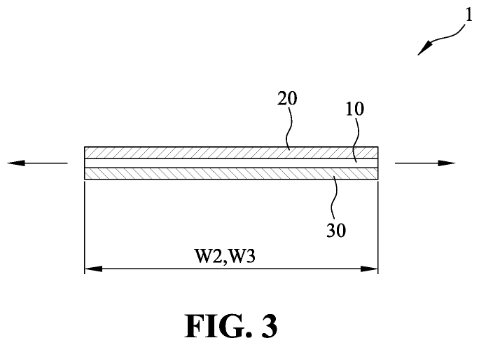

As shown in FIG. 3, when the elastic non-woven fabric 1 is stretched to the condition that the two elastic cloths 20 and 30 become flat shapes, the elastic film 10 is stretched from the first natural width W1 to the first stretched width W2, while the two elastic cloths 20 and 30 are restored to the second natural width W3.

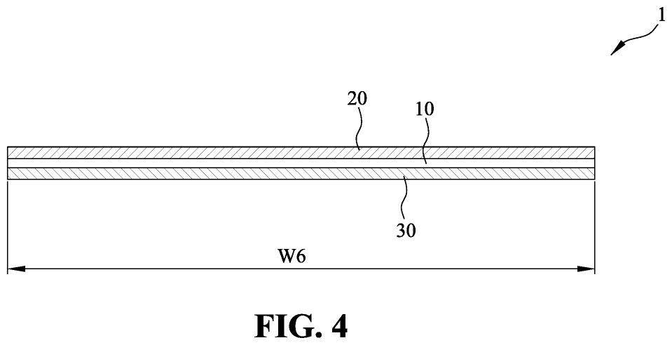

As shown in FIG. 4, when the elastic non-woven fabric 1 is stretched to a maximum limit width W6, the elastic film 10 is further stretched to excess the first stretched width W2 due to its elasticity, but not to a maximum limit width of the elastic film 10, while the two elastic cloths 20 and 30 are stretched to the maximum limit width W6. In other words, the weft-direction stretching limit of the elastic non-woven fabric 1 is equal to that of the two elastic cloths 20 and 30, but less than that of the elastic film 10.

In a preferable embodiment, the stretch range of the elastic film is 200%, and the stretchability of each of the elastic cloths is 200%. When the elastic non-woven fabric 1 has the third natural width W5, the elastic film 10 and the two elastic cloths 20 and 30 totally provide the potential for being stretched to four times of width, such that the elastic non-woven fabric 1 is provided with the potential for being stretched to four times its width. The elastic non-woven fabric 1 reaches the maximum limit width W6 when it is stretched to four times its width. At this time, the elastic film 10 can provide four times of elastic contraction force. Therefore, the elastic non-woven fabric 1 can be contracted back to the third natural width W5 again.

For example, the first natural width W1 of the elastic film 10 is 80 cm. When the elastic film 10 is moved to the bonding station 4, the first stretched width W2 of the elastic film 10 is 160 cm. At this time, the user needs to select two elastic cloths 20 and 30 with a second natural width W3 of 160 cm and bonds them respectively to the upper surface 11 and the lower surface 12 of the elastic film 10 which has been stretched to the first stretched width W2 of 160 cm. The elastic non-woven fabric 1 is contracted to the third natural width W5 after leaving the bonding station 4. The third natural width W5 of the elastic non-woven fabric 1 depends on the deformation rate of the elastic film 10 used, but is about 80 cm.

It is important that the elastic film 10 and the two elastic cloths 20 and 30 provide the elastic non-woven fabric 1 with the potential to be stretched to four times its width, such that the elastic non-woven fabric 1 can be stretched to a maximum limit width W6 of 320 cm. Meanwhile, the elastic film 10 can provide four times of elastic contraction force, such that the elastic non-woven fabric 1 can be contracted back to the third natural width W5 of about 80 cm again.

In summary, by bonding the two elastic cloths 20 and 30 respectively to the upper surface 11 and the lower surface 12 of the elastic film 10 after stretching the elastic film 10 in advance, it is possible for the elastic non-woven fabric 1 of the present invention to have high stretchability and high tensile strength. Therefore, the elastic non-woven fabric 1 will not have serious wrinkles on the surfaces thereof and will not be easily torn broken.

In addition, because the stretchability of the elastic non-woven fabric 1 is greatly improved, the user can use a smaller cutting width. Therefore, in the factory, it is possible to divide each cylindrical master-roll of the elastic non-woven fabric 1 into more cylindrical sub-rolls of the elastic non-woven fabric 1, thereby improving the production efficiency.

The mentioned above are only preferred embodiments for explaining the present invention but intend to limit the present invention in any forms, so that any modifications or verification relating to the present invention made in the same spirit of the invention should still be included in the scope of the invention as intended to be claimed.

What is claimed is:

1. An elastic non-woven fabric manufactured by bonding a pre-stretched elastic film and elastic cloths, comprising:
an elastic film, wherein a width that the elastic film is under a condition of equal to 100% of a natural width thereof is defined as a first natural width; a width that the elastic film is under a condition of more than 100% of the natural length thereof is defined as a first stretched width; and a stretch range that the elastic film is stretched from the first natural width to the first stretched width is 0-300%; and
two elastic cloths, wherein each of the elastic cloths has a stretchability of 150-300%; a width that each of the elastic cloths is under a condition of equal to 100% of a natural width thereof is defined as a second natural width; the second natural width of each of the elastic cloths are equal to the first stretched width of the elastic film; and under a condition that the two elastic cloths are maintained at the second natural width thereof, the two elastic cloths are respectively bonded to an upper surface and a lower surface of the elastic film which has been stretched to the first stretched width.

2. The elastic non-woven fabric according to claim 1, wherein the stretch range of the elastic film is 200%, and the stretchability of each of the elastic cloths is 200%.

3. The elastic non-woven fabric according to claim 1, wherein under the condition that the two elastic cloths are maintained at the second natural width thereof, the two elastic cloths are respectively bonded, by means of ultrasonic, hot pressing or adhesive, to the upper surface and the lower surface of the elastic film which has been stretched to the first stretched width.

4. The elastic non-woven fabric according to claim 1, wherein the elastic film includes a polystyrene copolymer material of a styrene-butadiene block copolymer, a styrene-ethylene-butylene-styrene block copolymer (SEBS) or a thermoplastic polyolefin elastomer (TPO), or includes a thermoplastic polystyrene elastomer (TPS).

5. The elastic non-woven fabric according to claim 1, wherein each of the elastic cloths includes polypropylene fibers or polyethylene fibers.
